(19) United States
(12) Patent Application Publication
(10) Pub. No.: US 2004/0051026 A1
(43) Pub. Date: Mar. 18, 2004

(54) Mold core coating

(76) Inventor: Robert William Flynn, Littleton, CO (US)

Correspondence Address: SHERIDAN ROSS PC, 1560 BROADWAY, SUITE 1200, DENVER, CO, 80202

(21) Appl. No.: 10/247,109

(22) Filed: Sep. 18, 2002

(51) Int. Cl. C25D 1/10; C25D 3/12; B29C 33/38; B05D 1/36

(52) U.S. Cl. 249/116; 427/402; 427/133

(57) ABSTRACT

A mold construction is provided having a layered configuration including a substrate or mold core preferably of ampcoloy, an intermediate or primer coat preferably of electroless nickel, and an outer mold surface layer made of a high strength metal preferably of titanium. The mold construction is particularly advantageous for use in molding glass objects. The electroless nickel undercoat or primer coat serve to adhere the softer ampcoloy substrate to the high strength outer layer of titanium alloy. The electroless nickel also provides some elasticity for the outer layer of titanium alloy layer to reduce cracking and flaking of the titanium alloy. The layer of titanium alloy provides good strength and durability to withstand abrasive contact with the molten glass, while the ampcoloy still facilitates high thermal conductivity for reducing mold cycle times.

### FIELD OF THE INVENTION

This invention relates to the manufacture of molds and, more particularly, to a mold construction including a layered coating especially adapted for molding of glass material, and a method relating to the manufacture of such a mold.

### BACKGROUND OF THE INVENTION

Various types of molds have long been used for preparing shaped articles made from a wide range of materials such as thermoplastic resins, glass, and other materials which can be placed in a molten form for injection or compression within a mold. Some of the different types of molding processes include blow molding, compression molding, injection molding, and injection compression molding. Molds for these type of processes are typically manufactured from metal having high thermal conductivity.

Blow molding involves the extrusion of a molten tube of resin called a parison into a mold. The mold closes around the parison, pinching the bottom of the parison closed. A gas such as air is then introduced causing the tube to expand against the cooled surfaces of the mold.

In compression molding, composite blanks of glass reinforced thermoplastic sheets are heated. The material is heated above its melting point, or if an amorphous material is used, at least substantially above its glass transition temperature. When the composite blanks are heated, they expand due to the recoil forces within the fibers. The hot blanks are then pressed between cool mold surfaces which are below the melting point or glass transition temperature.

Injection molding involves the injection of molten thermoplastic resin into a mold apparatus. Molds for injection molding of thermoplastic resin are usually made from a metal such as iron, steel, stainless steel, aluminum alloy, or brass. These materials are particularly advantageous because they have high thermal conductivity, thus allowing the melt of the thermoplastic resin to cool rapidly, thereby shortening the molding cycle time.

For injection compression molding, this is a combined process wherein a hot thermoplastic melt is injected into a mold cavity. The parting line of the mold is placed in an open position, or is allowed to be forced open by the injected melt. The clamping force is increased initiating the compression stroke of the mold, forcing the melt to fill the cavity. In many instances, the velocity of the melt front through the cavity changes as the injection stroke stops and the compression stroke begins.

In each of the above described processes, there are certain disadvantages associated with a fast cooling resin during the molding operation. For example, in injection molding, cooling of the injected material at too rapid of a rate causes the injected resin to freeze instantaneously at the mold surface, thus creating a thin solid layer which restricts the flow of the molten material through the remaining cavity portions of the mold.

In order to slow down the rate at which the injected material cools, multi-layer mold constructions have been developed wherein a metal core has an insulated layer bonded thereto which slows the initial cooling of the resin during the molding operation. Accordingly, the insulating layer is typically made of a material having low thermal conductivity, yet also having good resistance to high temperature degradation, thereby permitting the mold to be used in repeated high temperature cycles. Resinous insulating layers have a major disadvantage in that they are not mechanically strong and are easily abraded upon contact. Insulating layers made of a resin material may also suffer from creating molded articles having surface imperfections. Furthermore, molds which include resinous insulating layers are not adapted for molding glass, as the glass may have a hardness which would destroy the insulating layer.

It is also known to place one or more skin layers of hard material, typically metal, bonded to the insulating layer. Skin layers may be deposited by such operations as electroless deposition, electrolytic deposition and combinations thereof. However, such deposition operations introduce their own problems into the mold fabricating process. It is well known, for example, that some metal layers do not adhere well to resinous substrates. Thus, the metal skin layers suffer from cracking.

One example of a reference which discloses a multi-layer injection mold includes the U.S. Pat. No. 5,535,980. This reference discloses a mold construction including an insulating layer preferably of resin that is deposited on a metal core. A second layer comprising a metal which is suspended in another layer of resin is deposited upon the insulating layer. The second layer may contain metal in platelet form, or may contain the metal in other forms such as fiber or irregular whisker shapes.

U.S. Pat. No. 5,124,192 discloses a mold for use in producing plastic parts wherein the mold includes a multi-layered core structure. A number of different types of metals are disclosed, to include nickel which may be used as a skin layer as well as in an insulation layer.

U.S. Pat. No. 5,641,448 discloses a method for making molds used for producing prototype plastic parts. In the preferred embodiment, the mold core is shown as including an outer shell or skin of electroless nickel.

One particularly advantageous material for use in mold construction which has extremely high thermal conductivity, therefore allowing a high rate of heat transfer from the molten material through the mold core, is a material known as ampcoloy. Ampcoloy is an alloy manufactured by Ampco Metal of Marly, Switzerland. U.S. Pat. Nos. 5,376,317; 6,290,882; and 6,352,426 each disclose the use of ampcoloy within mold constructions. Ampcoloy is a copper based alloy, which may also include minor compositions of beryllium, cobalt, and/or nickel. Although ampcoloy has outstanding conductivity for reducing mold cycle times, ampcoloy has a relatively low hardness. Therefore, ampcoloy is not adequate for molding glass.

It is also generally known to place various types of coatings on industrial parts in order to increase lubricity, corrosion resistance, and wear life. However, one particular drawback with many of these coatings is the inability for the coatings to adequately adhere to metallic substrates, as well as the inability of such coatings to withstand repeated heating cycles, such as encountered in molding processes.

Although the foregoing prior art may be adequate for its intended purposes, there still remains a need for a mold construction wherein high thermal conductivity of the mold is maintained for purposes of reducing cycle time; but the mold is of a durable and mechanically strong construction so that materials such as glass may be molded without damage occurring to the contact surfaces of the mold.

### SUMMARY OF THE INVENTION

The present invention in one aspect is a new mold construction which utilizes a multiple layer approach for providing desired thermal conductivity and durability. The mold core construction comprises a substrate or mold core made of an alloy such as ampcoloy. An electroless nickel coating is applied to the ampcoloy. Then, another metal layer or coating is applied over the electroless nickel in the form of a high strength metal, such as Futura™ Futura™ is a titanium alloy comprising minor compositions of aluminum, thereby forming a titanium nitride coating. Futura™ is manufactured by Balzers of Balzers, Liechtenstein.

Use of the ampcoloy provides reduced cycle time, and the ampcoloy is protected by the overcoating of the titanium alloy, which can withstand the abrasive nature of glass molding. The electroless nickel acts as a primer coating wherein the electroless nickel serves to adequately bond the ampcoloy and the titanium alloy.

Ampcoloy, as well as many titanium based alloys, have poor adhesion characteristics making them more difficult to use in combination with other mold layers. Electroless nickel exhibits good adhesion characteristics which allows the nickel to act as a primer coat for adequately bonding the titanium alloy to the mold core of ampcoloy. Therefore, in another aspect of the invention, a novel primer coating is provided in the form of an electroless nickel which is situated between a mold core layer and an exposed mold surface layer made of a higher strength metal.

Further advantages of the invention will become apparent from a review of the following figure, taken along with the accompanying detailed description.

### BRIEF DESCRIPTION OF THE DRAWINGS

FIG. 1 is a simplified schematic diagram illustrating a cross-section of a mold constructed in accordance with the present invention.

### DETAILED DESCRIPTION

The present invention relates to a new mold construction, and a method of mold manufacture wherein the mold construction comprises three primary layers or constituents. The mold includes a substrate or mold core made of a high thermal conductive material such as ampcoloy, an exposed mold surface made of a high strength metal such as titanium, and a bonding or primer coating of electroless nickel which adequately adheres the high strength titanium coating to the softer ampcoloy core.

One example of a manufacturer of electroless nickel includes Armoloy of Decalb, Ill. A preferred electroless nickel coating contains about 5-15% of phosphorous. Electroless nickel in the form of a high nickel/low phosphorous alloy deposited by chemical reduction without electrical current is a more corrosion resistant solution than electro-plated nickel. On properly prepared substrates, electroless nickel is typically free of pores and other surface abnormalities. Electroless nickel deposits can also be evenly distributed over surfaces of even complex parts. Accordingly, total thickness of an electroless nickel deposit can be reduced, thus allowing close tolerances to be maintained. Electroless nickel has sufficient hardness, lubricity, wear resistance, and uniform deposit thickness which makes it an ideal material to be used as a primer or undercoat for the exposed mold layer of high strength titanium alloy. Electroless nickel coatings surpass most MIL spec standards for bend tests without any indications of flaking or other surface failures. Even if cracking of the electroless nickel coat occurs, the cracking is not typically accompanied by flaking, demonstrating that the adhesion of the electroless nickel primer is well suited for mold construction.

The titanium alloy which may be used in the mold construction of the present invention, as discussed above, may be made of a material known as Futura™ titanium aluminum nitride. Other acceptable coatings include other high strength titanium alloys, such as titanium nitride, titanium carbon nitride, chromium nitride, chromium carbide, and titanium carbide/carbon. Each of these alloys are sold under the trademark Balinit® of Balzers.

Various types of ampcoloy are available from Ampco Metal, to include a group of ampcoloy products sold under the trademark MoldMate™. Specifically, acceptable ampcoloy types include MoldMate™ 18,90,97,940,21 w and 22 w. In testing, MoldMate™ 90 and 940 have been found to be particularly effective. For each of these alloys, they comprise primarily a balance of copper and a small percentage of other metals to include beryllium or cobalt.

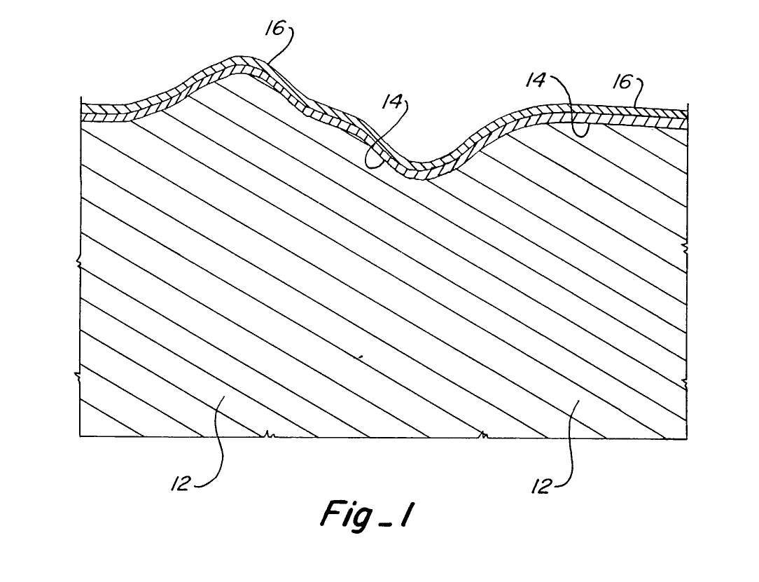

Now referring to FIG. 1, a representative sample of a cross-section of a mold in accordance with the current invention is shown. This Figure is not to scale in order to visualize the three layers of the mold construction. In practice, the electroless alloy coatings are of such thickness that they would be difficult to view with the unaided eye. A substrate or mold core layer of ampcoloy 12 is provided in the shape of the article to be molded. The core layer 12 can be any shape depending upon the shape of the article to be molded. A primer or undercoat of electroless nickel 14 is deposited over the ampcoloy substrate. Preferably, the electroless nickel is deposited by an auto-catalytic process (such as a submerged bath). Preferably, the electroless nickel is applied with a thickness of three ten thousands of an inch (0.0003). A titanium alloy 16 such as Futura™ is then deposited over the electroless nickel layer.

Preferably, the titanium coating is also applied at approximately three ten thousands of an inch thick (0.0003). The titanium coating may be applied by known vapor deposition processes.

For the electroless nickel, an acceptable range of the thickness would be 0.0001 of an inch to 0.005 of an inch. For Futura™ or other Balinit® products, an acceptable range of thickness would be 0.0001 to 0.0003 of an inch.

Although the electroless nickel and titanium coatings are placed over the ampcoloy, these coatings do not significantly degrade the high thermal conductivity of the ampcoloy because these coatings can be applied in extremely thin layers.

Because the electroless nickel coating is appreciably softer than the titanium coating, the electroless nickel also provides some give or elasticity, therefore enhancing the ability of the titanium overcoat to better withstand shock. Thus, the electroless nickel undercoating helps to absorb the shock thereby preventing flaking or cracking of the titanium overcoat.

By the foregoing, a mold construction is provided wherein a mold cycle time may be minimized, yet the type of material which may be molded includes hard material such as glass. The high strength layer of titanium is resistant to abrasion or other damage by the material to be molded. The intermediate or primer coating of electroless nickel allows the hard exposed coating of titanium to adhere well to the ampcoloy substrate. Furthermore, the electroless nickel primer provides some give or elasticity in relation to the titanium overcoat, thereby reducing cracking or flaking of the titanium overcoat. The overall mold construction is very durable, and is particularly adapted for molding of glass material.

Although the mold construction and method of the present invention is particularly suited for molding glass, the invention is generally suited for many other types of materials such as thermoplastic resins used in injection molding.

The foregoing invention has been described with respect to a preferred embodiment; however, various changes and modifications may be made which fall within the spirit and scope of the invention.

What is claimed is:

1. A multi-layer mold for molding materials, said multi-layer mold comprising:
a metal core comprising a copper alloy;
an intermediate layer comprising an electroless nickel deposited on said metal core; and
a second layer comprising a titanium alloy deposited on said intermediate layer.

2. A mold, as claimed in claim 1, wherein:
said intermediate layer is about 0.0003 of an inch thick.

3. A mold, as claimed in claim 1, wherein:
said second layer is deposited on said first layer at a thickness of about 0.0003 of an inch thick.

4. A mold, as claimed in claim 1, wherein:
said intermediate layer is in a range between about 0.0001 of an inch to 0.005 of an inch.

5. A mold, as claimed in claim 1 wherein:
said second layer is in the range of between about 0.0001 of an inch to 0.0003 of an inch.

6. A mold, as claimed in claim 1, wherein:
said copper alloy comprises ampcoloy.

7. A mold, as claimed in claim 1, wherein:
said second layer of titanium alloy is selected from the group consisting of titanium nitride, titanium carbon nitride, chromium nitride, chromium carbide, and titanium carbide/carbon.

8. A method of manufacturing a mold, said method comprising the steps of:
creating a mold core of a desired shape to conform to a shape of an article to be molded, said mold core being made of a copper based alloy;
applying a primer coating of an electroless nickel over the mold core at a desired thickness; and
applying an outer layer of a titanium alloy over the primer coating at a desired thickness, wherein the primer coating adequately binds the mold core and the outer layer.

9. A method, as claimed in claim 8, wherein:
said first applying step is achieved by an auto-catalytic process.

10. A method, as claimed in claim 8, wherein:
said second applying step is achieved by vapor deposition.

11. A method, as claimed in claim 8, wherein:
said copper based alloy includes ampcoloy.

12. A method, as claimed in claim 8, wherein:
said titanium alloy is selected from the group consisting of titanium nitride, titanium carbon nitride, chromium nitride, chromium carbide, and titanium carbide/carbon.

13. A method, as claimed in claim 8, wherein:
said primer coating is applied at a range of thickness of between 0.0001 and 0.005 of an inch thick.

14. A method, as claimed in claim 8, wherein:
said titanium alloy is applied at a range of thickness between 0.0001 to 0.0003 of an inch thick.

15. A multi layer mold for molding materials, said multi-layer mold comprising:
a metal core comprising a metal alloy of a medium hardness;
an intermediate primer layer comprising a metal of a lower hardness which is deposited over said metal core in an auto-catalytic process; and
a second layer comprising a metal of higher hardness deposited on said intermediate layer, said second layer being deposited upon said intermediate layer by vapor deposition.

16. A mold, as claimed in claim 15, wherein:
said metal core comprises a copper alloy.

17. A mold, as claimed in claim 15, wherein:
said intermediate layer comprises electroless nickel.

18. A mold, as claimed in claim 15, wherein:
said second layer comprises a titanium alloy.

19. A mold, as claimed in claim 15, wherein:
said intermediate layer is in a range between about 0.0001 of an inch to 0.005 of an inch thick.

20. A mold, as claimed in claim 15, wherein:
said second layer is in the range of between about 0.0001 of an inch to 0.0003 of an inch thick.

21. A mold, as claimed in claim 15, wherein:
said copper alloy comprises ampcoloy.

22. A mold, as claimed in claim 15, wherein:
said second layer of titanium alloy is selected from the group consisting of titanium nitride, titanium carbon nitride, chromium nitride, chromium carbide, and titanium carbide/carbon
